(19) United States
(12) Patent Application Publication
(10) Pub. No.: US 2025/0019313 A1
(43) Pub. Date: Jan. 16, 2025

(54) FAST DENSIFIED CARBON-CARBON COMPOSITES AND FABRICATION METHOD

(71) Applicant: Edward John Andrew Pope, Westlake Village, CA (US)

(72) Inventor: Edward John Andrew Pope, Westlake Village, CA (US)

(21) Appl. No.: 18/737,203

(22) Filed: Jun. 7, 2024

(30) Foreign Application Priority Data
Jul. 11, 2023 (US) 63/513047

(51) Int. Cl. C04B 35/83; C04B 35/52; C04B 35/532; C04B 41/00

(52) U.S. Cl. CPC C04B 35/83; C04B 35/521; C04B 35/532; C04B 41/0018; C04B 41/0072; C04B 41/009; C04B 2235/48; C04B 2235/5248; C04B 2235/614; C04B 2235/6581; C04B 2235/666; C04B 2235/77

(57) ABSTRACT

A densified carbon-carbon composite material exhibits superior strength and toughness, relative to low density carbon-carbon composites. The process densification of a set of carbon fibers with a non-fibrous carbon material, resulting in a precursor carbon matrix, stabilizing the precursor carbon matrix, resulting in a stabilized carbon matrix, and densifying the stabilized carbon matrix using a field assisted sintering technology (FAST) process, resulting in the high density carbon-carbon composite material.

### FIELD

The present disclosure relates to methods and apparatus for fabricating high density carbon-carbon (HDCC) composites, and to the materials produced thereby.

### BACKGROUND OF THE INVENTION

Carbon-carbon composites combine a carbon fiber in a carbon matrix. Carbon-carbon composites are useful for certain high-temperature applications, and may enable equipment to endure higher operating temperatures, which can be advantageous.

### SUMMARY OF THE INVENTION

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect of the disclosure, a method for making a carbon-carbon composite impregnating a set of carbon fibers with a flowable resinous carbon-containing material, resulting in a precursor matrix, stabilizing the precursor matrix, resulting in a stabilized matrix, and densifying the stabilized matrix using a field assisted sintering technology (FAST) process, resulting in a densified carbon-carbon composite material.

In an aspect, the set of carbon fibers may be, or may include a carbon fabric. The fabric may be a woven, braided, needle-punched, bundled, or non-woven material.

In another aspect, the FAST process is applied at a temperature in a range of 16000 to 28000. For example, the stabilizing temperature may be 18000, or within 5% of 18000 (e.g., 18000±90C). In addition, the FAST process may be applied at a pressure in a range of 50 MPa to 300 MPa, for example, 75 MPa. The method may further include controlling the temperature of the FAST process by modulating an oscillating DC voltage applied through the stabilized matrix. The FAST process may be applied for a total time of less than 1200 seconds before terminating.

In an aspect, the FAST densified carbon-carbon composite material that results has a porosity of less than 10%. For example, the FAST densified carbon-carbon composite material may have a porosity of less than 5%.

In another aspect, the FAST densified carbon-carbon composite material that results has a density of greater than 1.70 grams per cc (g/cc). For example, the FAST densified carbon-carbon composite material may have a density greater than 1.90 grams per cc (g/cc), up to and including 2.4 grams per cc (g/cc).

The method described is believed to be the first carbon-carbon fabrication technique successfully using a FAST densification process to achieve a low porosity and high density carbon-carbon. Although HIPIC also produces high density carbon-carbon composites, HIPIC is subject to other limitations. Thus, the present technology provides the first FAST densified carbon-carbon composite material characterized by a density of greater than 2.1 g/cc. The FAST densified carbon-carbon composite may include a carbon fiber material in a carbon matrix. The FAST densified carbon-carbon composite material may include an interface coating, for example, a coating selected from pyrolytic carbon (PyC) or boron nitride (BN). The FAST densified carbon-carbon composite material may be characterized by a bulk density greater than 2.1 g/cm³.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the examples may be employed. Other advantages and novel features will become apparent from the following detailed description when considered in conjunction with the drawings and the disclosed examples, which encompass all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify like elements correspondingly throughout the specification and drawings.

FIG. 1 is a flow chart diagraming a FAST process as applied to the processing of carbon-carbon composites.

FIG. 2 is a table showing the basic properties of the precursor carbon-carbon composite and the properties of the FAST densified carbon-carbon composites for a few selected conditions.

### DETAILED DESCRIPTION OF THE INVENTION

This non-provisional application claims the benefit of and incorporates by reference, in its entirety, U.S. provisional application Ser. No. 63/513,047, filed on Jul. 11, 2023.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

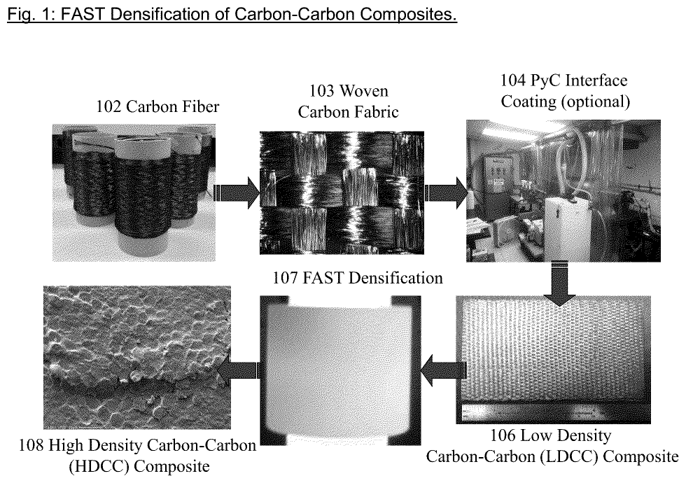

Referring to FIG. 1, a high density carbon-carbon material is diagrammed, after being produced by application of Field Assisted Sintering Technology (FAST) processing 107 to the final densification of the carbon-carbon composite material 108. Carbon-carbon composites are typically composed of a fiber re-enforcement phase 102, may contain an interface coating phase 104, and a carbon matrix phase 106. The fiber re-enforcement phase 102 may be, or may include a carbon fiber. The fiber re-enforcement phase 102 may be processed into the carbon-carbon starting as a woven 103, braided, needle-punched, bundled, or non-woven material. The fiber re-enforcement phase 102 may be continuous or discontinuous.

The interface coating phase 104 on the surface of the fiber filaments may be, or may include, a carbon or ceramic material, such as boron nitride (BN). The carbon-carbon matrix phase 106 may be, or may include, a ceramic particulate material, including but not limited to silicon carbide (SiC). The starting (or “precursor”) matrix for forming the carbon-carbon should contain less than 30 percent open porosity, preferably less than 10 percent, prior to FAST processing. Applications for FAST-densified carbon-carbon composites may include, but are not limited to, ballistic nose tips, hypersonic leading edge, hypersonic aeroshells, hypersonic propulsion components, re-entry heat shields, nuclear reactor components, rocket or missile components, or any other structural component used at an extremely high temperature.

Field Assisted Sintering Technology (FAST), also known as Spark Plasma Sintering (SPS), was once described as “hot pressing on steroids.” Field Assisted Sintering Technology has diverse areas of application, including but not limited to net-shaped forming components, ceramic-metal joining, turbine components, thermo-electric materials, ultra-high temperature ceramic tiles, cutting tools, sensors, and body armor. Much research has been conducted throughout the world on this technology. The process can be applied to a wide range of materials, including glasses, ceramics, metals, and functionally graded materials. It has a process cycle time that is typically 70-80 times faster than most conventional methods. The FAST process is well suited for achieving high theoretical density net shaped components, which is important for turbine blades and vanes, missile nosetips, leading edge materials, and aeroshells on hypersonic missiles, among other things. Additionally, it is 20-33 percent more energy efficient than conventional methods, as the material is heated directly by its own electrical resistance to a current passed through it.

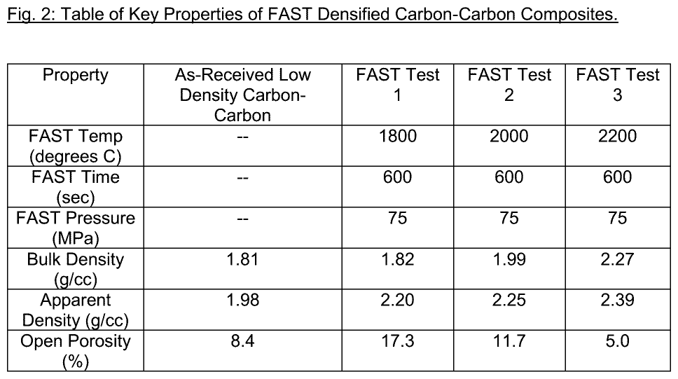

In Table 1 in FIG. 2, the density and porosity are given for carbon-carbon plates processed between 1800 to 22000 for 10 minutes under given pressures. As can be readily seen, density increases, and porosity decreases as a function of increased FAST processing temperature and pressure. Density is expressed in units of g/cm³.

The finished carbon-carbon products produced using the method parameters indicated herein were tested for various properties. The tests results demonstrated that FAST (SPS) processing can be applied to final CMC densification to achieve low porosity and high density, evidence of composite fracture behavior and fiber pull out, and a carbon-carbon composite with undetectable oxygen contamination (or any other contaminants). FIG. 2 is a table illustrating desirable properties of the densified CMCs that can be produced using the methods disclosed herein. A FAST processing temperature of 22000 resulted in the most optimal characteristics overall, at least for FAST processing conditions of 10 minutes at 75 MPa applied pressure.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

U.S. Pat. Nos. 5,389,152 and 5,733,611 teaches that a porous preform is densified by heating while immersed in a precursor liquid. Heating is achieved by passing a current through the preform or by an induction coil immersed in the liquid. This process demonstrates the ability to rapidly densify carbon-matrix composites by an alternative method than PIP with phenolic resin and CVI with gaseous carbon precursors.

U.S. Pat. No. 5,057,254A teaches that a carbon-carbon composite is produced by impregnating a primary-formed product consisting essentially of carbon fibers and a carbonized or graphitized matrix with a carbonaceous pitch, heat-treating the thus-impregnated primary-formed product under hot isostatic pressing and carbonizing or graphitizing the thus heat-treated primary-formed product.

U.S. Pat. No. 8,268,207B2 teaches a method of “A method of manufacturing pitch-based carbon-carbon composite useful as a brake disc.” The method uses a mixture of pitch based densification followed by CVI carbon matrix infiltration.

U.S. Pat. No. 6,410,088B1 teaches a method of “densifying porous structures by chemical vapor infiltration. In characteristic manner, said densification method is implemented using toluene as a precursor for carbon. Said toluene is generally used mixed with at least one carrier gas.”

U.S. Pat. No. 6,432,477 B1 teaches a “porous preform body is infiltrated with carbon by a thermal gradient process using a multi-portion heating element to heat the body. Selected portions of the heating element are supplied with power to create the thermal gradient between different areas of the preform body.”

International Patent Application WO 2008/052923 A3 “describes a method of CVI densification in which particular arrangements and mixtures of undensified porous substrates and partially densified porous substrates are arranged in particular ways in order to use the thermal characteristics of the partially densified porous substrates to better distribute heat throughout a CVI furnace and thereby improve densification.”

U.S. Pat. No. 6,878,331 B2 and U.S. Pat. No. 7,207,424 B2 teaches that carbon composite materials having final densities of 1.6-1.8 g/cc are possible by hot-pressing methods. Interesting that their method also involves “one or two infiltration cycles using a pitch or other carbonaceous material to fill Voids in the composite and rebaking.”

U.S. Pat. No. 7,927,523 B2 teaches that using pitch-based carbon-carbon composites followed by final densification by CVI/CVD processing can achieve a density of 1.7 g/cc “or higher.” Nowhere in the patent does it show an example of a density higher than 1.7 g/cc, it should be noted.

U.S. Pat. No. 7,968,192 B2 teaches “The invention relates to a method of inhibiting the oxidation of a porous carbon-carbon composite. The invention relates to an oxidation inhibiting composition, and to carbon-carbon composites treated by the method.”

U.S. Pat. Nos. 10,464,849 and 10,774,007 describe how FAST densified composites of SiC fibers and carbon fibers in a matrix of SiC can be made into composites of extremely high density and low porosity. The invention herein described is a logical but unobvious extension of that approach.

1. A method for making a carbon matrix composite, the method comprising:
a) impregnating a set of carbon fibers with a flowable carbon-forming resin material, resulting in a precursor matrix;
b) stabilizing the precursor matrix, resulting in a stabilized matrix;
c) densifying the stabilized matrix using a field assisted sintering technology (FAST) process, resulting in a densified carbon matrix composite material with a bulk density between 1.7 and 2.4 g/cc.

2. The method of claim 1, wherein the set of fibers comprises a carbon fabric.

3. The method of claim 1, further comprising coating the set of carbon fibers with a layer of interface coating, prior to the impregnating.

4. The method of claim 1, wherein the flowable carbon-forming resin material comprises a polymer and the impregnation comprises a polymer-impregnation-pyrolysis (PIP) process.

5. The method of claim 1, wherein the precursor matrix is characterized by an open porosity of less than twenty percent.

6. The method of claim 1, wherein the stabilizing comprises heat treating in an inert atmosphere or vacuum at a temperature in a range of 14000 to 28000.

7. The method of claim 1, wherein the flowable carbon-forming resin material is filled with a ceramic powder of, but not limited to, silicon carbide (SiC), zirconium carbide (ZrC), hafnium carbide (HfC), tantalum carbide (TaC), or tungsten carbide (WC).

8. The method of claim 1, wherein the flowable carbon-forming resin material is doped with a polymer of, but not limited to, silicon carbide (SiC), zirconium carbide (ZrC), hafnium carbide (HfC), tantalum carbide (TaC), or tungsten carbide (WC).

9. A method for making a carbon matrix composite, the method comprising:
a) densifying porous structures by chemical vapor infiltration (CVI).
b) densifying the stabilized matrix using a field assisted sintering technology (FAST) process, resulting in a densified carbon matrix composite material with a bulk density between 1.7 and 2.4 g/cc.

10. The method of claim 9, wherein the set of fibers comprises a carbon fabric.

11. The method of claim 9, further comprising coating the set of carbon fibers with a layer of interface coating, prior to the impregnating.

12. The method of claim 9, wherein the precursor matrix is characterized by an open porosity of less than twenty percent.

13. The method of claim 9, wherein the stabilizing comprises heat treating in an inert atmosphere or vacuum at a temperature in a range of 14000 to 28000.

14. A method for making a carbon matrix composite, the method comprising:
a) a porous preform is densified by heating while immersed in a precursor liquid. Heating is achieved by passing a current through the preform or by an induction coil immersed in the liquid. This process demonstrates the ability to rapidly densify carbon-matrix composites by an alternative method than PIP with phenolic resin and CVI with gaseous carbon precursors.
b) densifying the stabilized matrix using a field assisted sintering technology (FAST) process, resulting in a densified carbon matrix composite material with a bulk density between 1.7 and 2.4 g/cc.

15. The method of claim 14, wherein the set of fibers comprises a carbon fabric.

16. The method of claim 14, further comprising coating the set of carbon fibers with a layer of interface coating, prior to the impregnating.

17. The method of claim 14, wherein the precursor matrix is characterized by an open porosity of less than twenty percent.

18. The method of claim 14, wherein the stabilizing comprises heat treating in an inert atmosphere or vacuum at a temperature in a range of 14000 to 24000.
